(19) United States
(12) Patent Application Publication
(10) Pub. No.: US 2017/0147864 A1
(43) Pub. Date: May 25, 2017

(54) FINGER RECOGNITION DEVICE, USER AUTHENTICATION DEVICE INCLUDING THE SAME, AND FINGER RECOGNITION METHOD THEREOF

(71) Applicant: Electronics and Telecommunications Research Institute, Daejeon (KR)

(72) Inventor: CHANG-GEUN AHN, Daejeon (KR)

(21) Appl. No.: 15/359,288

(22) Filed: Nov. 22, 2016

(30) Foreign Application Priority Data
Nov. 23, 2015 (KR) 10-2015-0164259
Jul. 22, 2016 (KR) 10-2016-0093564

(51) Int. Cl. G06K 9/00; G06F 21/32; H04L 9/32; G06F 3/041

(52) U.S. Cl. CPC G06K 9/00087; G06K 9/00926; G06F 3/0416; G06F 21/32; H04L 9/3231; G06F 2203/04106

(57) ABSTRACT

Provided is a finger recognition device including a signal generating unit configured to generate a biometric signal, a signal detecting unit configured to receive the biometric signal via a finger and detect the biometric signal, and a finger recognition unit configured to compare the detected biometric signal with stored signal information to recognize the finger.

### CROSS-REFERENCE TO RELATED APPLICATIONS

This U.S. non-provisional patent application claims priority under 35 U.S.C. §119 of Korean Patent Application Nos. 10-2015-0164259, filed on Nov. 23, 2015, and 10-2016-0093564, filed on Jul. 22, 2016, the entire contents of which are hereby incorporated by reference.

### BACKGROUND

The present disclosure herein relates to a finger recognition device, a user authentication device including the same, and a finger recognition method thereof

Recognition security devices ever developed are much diversified but the most widely used scheme is a fingerprint recognition scheme and an iris recognition scheme. The fingerprint recognition security device firstly scans a fingerprint on a finger through a fingerprint recognition sensor to store the scanned fingerprint as an image, create information from the image through various image recognition schemes to store and enroll the information, and compares, analyzes and determines later whether a read-in fingerprint is identical to the enrolled one. The iris recognition is performed with a process similar to the fingerprint recognition, and the two schemes are the same in that the two both use unique features of a body.

However, as reproductions of the fingerprint and iris become enabled recently, security devices using other unique features of the body besides the fingerprint and iris are being developed. A plurality of security devices that classify biometric signals such as electrocardiogram and perform recognition are being newly proposed, but there are many issues to be addressed. The most representative issue is that a recognition rate is very low, since a variation amount of a biometric signal is large according to a given environment, although there is a personal difference in characteristic biometric signal. Accordingly, methods are necessary in which the personal difference is clear, reproduction is almost impossible, and a difference between result values according to the environment is small, which result in a high recognition rate.

### SUMMARY

The present disclosure provides a finger recognition device capable of recognizing a finger of a user, a user authentication device including the same, and a finger recognition method thereof.

An embodiment of the inventive concept provides a finger recognition device including: a signal generating unit configured to generate a biometric signal; a signal detecting unit configured to receive the biometric signal via a finger and detect the biometric signal; and a finger recognition unit configured to compare the detected biometric signal with stored signal information to recognize the finger.

In an embodiment, the signal generating unit and the signal detecting unit may be electrically separated.

In an embodiment, the finger recognition unit may store the detected biometric signal as the signal information at a time of enrolling finger information.

In an embodiment, the finger recognition unit may encrypt the detected biometric signal and store the encrypted biometric signal as the signal information.

In an embodiment, the finger recognition unit may decrypt the encrypted biometric signal and compare the detected biometric signal with the signal information.

In an embodiment, the signal generating unit and the signal detecting unit may be activated, when the signal generating unit is touched by a first finger of a user and the signal detecting unit is touched by a second finger of the user.

In an embodiment, the signal detecting unit may detect the biometric signal, when the finger is worn with a specific ring.

In an embodiment of the inventive concept, a user recognition device includes: a fingerprint recognition sensor configured to recognize a fingerprint; a finger recognition sensor configured to recognize a finger; and a user recognition controller configured to control the fingerprint recognition sensor and the finger recognition sensor, wherein the finger recognition sensor comprises: a signal generating unit configured to generate a biometric signal; a signal detecting unit configured to receive the biometric signal via the finger to detect the biometric signal; and a finger recognition unit configured to compare the detected biometric signal with stored signal information to recognize the finger.

In an embodiment, the user recognition controller may primarily activate the fingerprint recognition sensor.

In an embodiment, the user recognition controller may activate the finger recognition sensor, after recognition of the fingerprint by the fingerprint recognition sensor.

In an embodiment, the user recognition device may further include a memory configured to store the signal information.

In an embodiment, the finger recognition unit may be realized in a touch screen.

In an embodiment, at least one of the fingerprint recognition sensor and the finger recognition sensor may recognize fingerprints or fingers of a plurality of users.

In an embodiment of the inventive concept, a user authentication device includes: a personal identification number (PIN)/pattern inputter configured to input a PIN or pattern for first user authentication; a finger recognition sensor configured to recognize a finger for second user authentication; and a user recognition controller configured to control the PIN/pattern inputter and the finger recognition sensor, wherein the finger recognition sensor comprises: a signal generating unit configured to generate a biometric signal; a signal detecting unit configured to receive the biometric signal via the finger to detect the biometric signal; and a finger recognition unit configured to compare the detected biometric signal with stored signal information to recognize the finger.

In an embodiment, the user authentication device may be a wearable device.

In an embodiment of the inventive concept, a finger recognition method of a user authentication device includes: generating a biometric signal; receiving the biometric signal via a finger; and comparing the received biometric signal with signal information.

In an embodiment, the finger recognition method may further include wearing a specific finger on the finger.

In an embodiment, the finger recognition method may further include storing the signal information in a memory inside the user recognition device.

In an embodiment, the storing of the signal information may include encrypting the signal information.

In an embodiment, the finger recognition method may further include detecting a touch by the finger.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 illustrates an exemplary finger recognition device according to an embodiment of the present inventive concept;

FIG. 2 illustrates an exemplary signal detected by a signal detecting unit according to an embodiment of the present inventive concept;

FIG. 3 illustrates an exemplary flowchart of a finger recognition method of a finger recognition device according to an embodiment of the present inventive concept;

FIG. 4 illustrates an embodiment of a finger operation for finger recognition of a finger recognition device according to an embodiment of the present inventive concept;

FIG. 5 illustrates another embodiment of a finger operation for finger recognition of a finger recognition device according to an embodiment of the present inventive concept;

FIG. 6 illustrates an exemplary finger recognition device according to another embodiment of the present inventive concept;

FIG. 7 is an exemplary flowchart illustrating a finger recognition method of the finger recognition device of FIG. 6;

FIG. 8 illustrates an exemplary user authentication device according to an embodiment of the present inventive concept;

FIG. 9 is an exemplary flowchart illustrating a user authentication method of the user authentication device of FIG. 8;

FIG. 10 illustrates an exemplary network environment including electronic devices according to various embodiments; and

FIG. 11 is an exemplary mobile device according to an embodiment of the present inventive concept.

### DETAILED DESCRIPTION

Hereinafter, an exemplary embodiment of the present invention will be described in detail with reference to the accompanying drawings such that a person skilled in the art may easily carry out the embodiments of the present invention.

Since various changes may be made and several forms may be embodied in the embodiments according to the concept of the present disclosure, the embodiments are intended to be illustrated in the drawings and described in detail herein. However, the present invention is not limited to the specific disclosed forms, and needs to be construed to include all modifications, equivalents, or replacements included in the spirit and technical range of the present invention.

It will be understood that, although the terms first, second, etc. may be used herein to describe various elements, these elements should not be limited by these terms. The above terms are used only to distinguish one component from another. For example, a first component may be referred to as a second component and likewise a second component may be referred to as a first component without departing from the scope of rights according to the concept of the present disclosure.

It will be understood that when an element is referred to as being “connected” or “coupled” to another element, it may be directly connected or coupled to the other element or intervening elements may be present. In the meantime, when it is mentioned that one component is “directly connected” or “directly accessed” to another component, it may be understood that no component is interposed therebetween. Other words used to describe the relationship between elements should be interpreted in a like fashion, e.g., “between” versus “directly between”, “adjacent” versus “directly adjacent”, etc.

Terms used herein are provided for merely explaining specific embodiments of the present disclosure, not limiting the disclosure. As used herein, the singular forms “a,” “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, components or combinations thereof, but do not preclude the presence or addition of one or more other features, integers, steps, operations, elements, components, or combinations thereof.

Unless otherwise defined, all terms used herein including technical or scientific terms are same as those generally understood by those skilled in the art. Terms such as those defined in the generally used dictionary should be interpreted as having the same meaning as that in terms of context in the related art, and are not interpreted as an ideal or excessively formal meaning unless clearly defined herein.

Hereinafter, exemplary embodiments of the inventive concept will be described in detail with reference to the accompanying drawings.

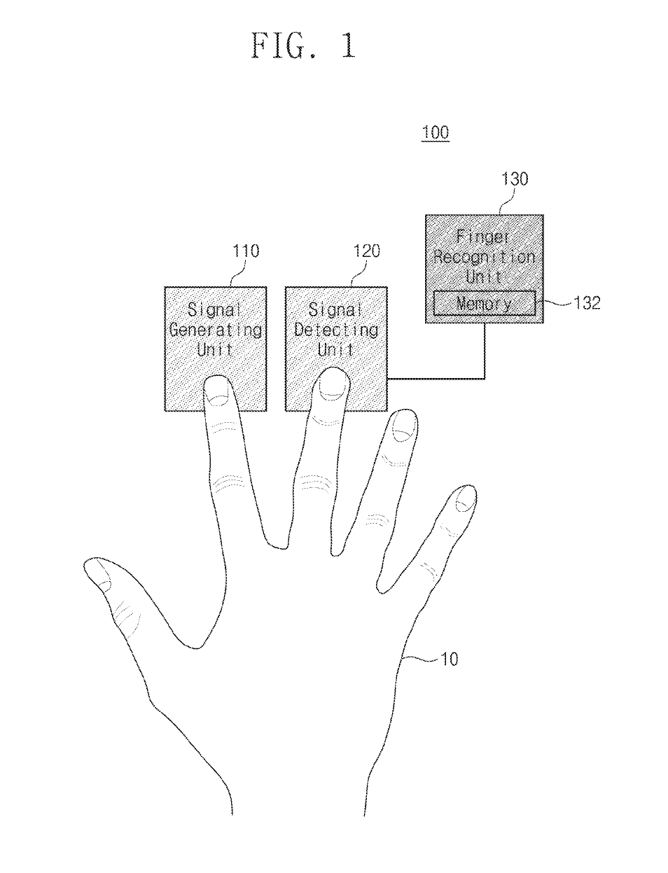

FIG. 1 illustrates an exemplary finger recognition device according to an embodiment of the present inventive concept. Referring to FIG. 1, a finger recognition device 100 may include a signal generating unit 110, a signal detecting unit 120, and a finger recognition unit 130.

The signal generating unit 110 may be realized to generate a specific signal. In an embodiment, the specific signal may be a biometric signal deliverable through a body. An impedance change characteristic of the signal output from the signal generating unit 110 may be most easily caught with application of a voltage or current. In another embodiment, the specific signal may be an ultrasonic signal.

The signal detecting unit 120 may be electrically separated from the signal generating unit 110. The signal detecting unit 120 may be realized to receive the signal output from the signal generating unit 110 through a touched finger. The signal detecting unit 120 may be realized to detect a distortion of a biometric signal delivered through the finger. While transmitted through the finger, the biometric signal may be distorted according to the structure and constituent material, etc., of the finger. The signal detecting unit 120 may detect the signal distorted in this way.

In an embodiment, the signal detecting unit 120 may be realized with an envelope detector.

On the other hand, as illustrated in FIG. 1, when the signal generating unit 110 contacts a first finger of a user and the signal detecting unit 120 contacts a second finger of the user, the signal generating unit 110 and the signal detecting unit 120 may be activated.

The finger recognition unit 130 may be realized to store and/or compare the detected biometric signal. When a new signal is input thereafter, the finger recognition unit 130 may compare an input signal with stored signal information to perform user authentication, namely, recognize the user's finger. In other words, when a new signal is input, recognition security may be performed by analyzing whether the new signal has the same characteristics as stored finger characteristics.

In an embodiment, the finger recognition unit 130 may store signal information for a finger of a single user. In another embodiment, the finger recognition unit 130 may store signal information for fingers of a plurality of users.

The finger recognition unit 130 may include a memory 132 for storing signal information. In an embodiment, the memory 132 may be realized with a nonvolatile memory. The memory 132 of FIG. 1 exists in the finger recognition unit 130. However, the present inventive concept is not limited thereto. It should be understood that the memory for storing the signal information may also exist outside the finger recognition unit 130.

In an embodiment, the finger recognition unit 130 may be realized to encrypt signal information corresponding to a finger for personal information protection of a user and store the encrypted signal information in the memory 132. To this end, the finger recognition unit 130 may be realized to include an encryptor/decryptor therein for performing an encryption/decryption operation or use an external encryptor/decryptor.

FIG. 2 illustrates an exemplary signal detected by a signal detecting unit 120 according to an embodiment of the present inventive concept. Referring to FIG. 2, a propagation speed and a propagation delay of an ultrasonic wave, a shape, a maximum peak value, and a frequency characteristic of the detected signal may be caught by applying an ultrasonic signal. Therefore, information may be divided and recognized in more detail.

At this point, a frequency and magnitude of an input signal may be changed as necessary and signal changes from the signal detecting unit 120 may be made as information.

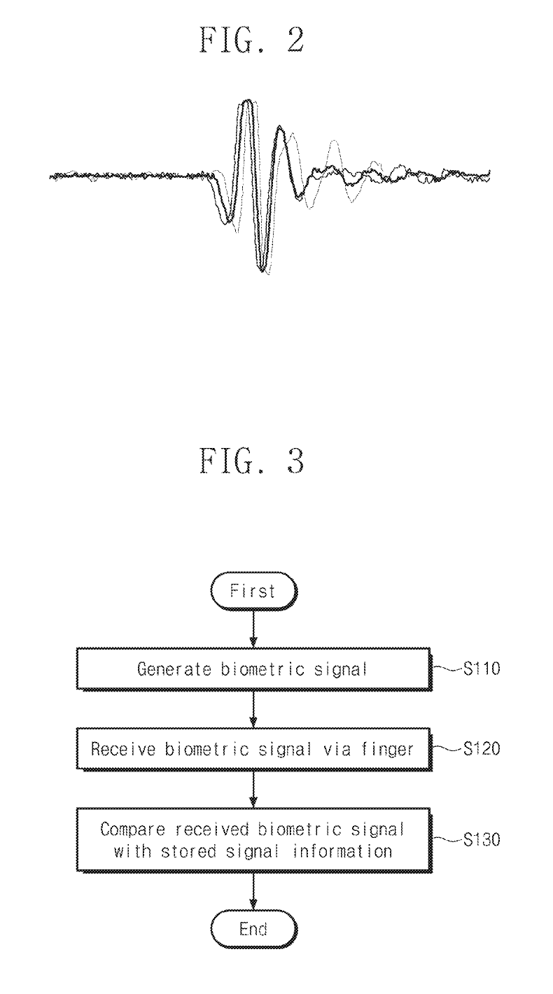

FIG. 3 illustrates an exemplary flowchart of a finger recognition method of the finger recognition device 100 according to an embodiment of the inventive concept. Referring to FIGS. 1 to 3, the finger recognition method may be performed as the following.

In order to perform the finger recognition operation, the signal generating unit 110 may generate a biometric signal (operation S110). The generated biometric signal may be transmitted to the signal detecting unit 120 through a finger 10. In other words, the signal detecting unit 120 may receive the biometric signal via the finger 10 (operation S120). The finger recognition unit 130 may compare the received biometric signal with the stored signal information to authenticate the user's finger (operation S130).

On the other hand, various methods other than the above-described method are applicable to any input signal in which a signal distortion may occur due to a difference in finger structure, finger operation, or material constituting a thing worn on the finger.

For example, the finger recognition device 100 of an embodiment of the present inventive concept may also recognize biometric signals according to various finger operations of the user.

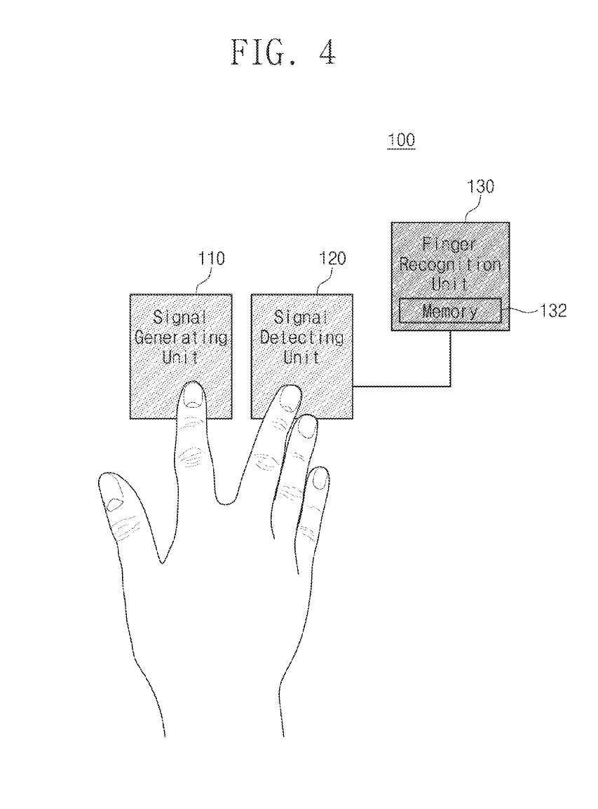

FIG. 4 illustrates an embodiment of a finger operation for finger recognition of a finger recognition device 100 according to an embodiment of the present inventive concept. Referring to FIG. 4, the finger recognition device 100 may recognize fingers of the user through the index finger touched on the signal generating unit 110 and the middle finger touched on the signal detecting unit 120. At this point, the index finger, the ring finger, and the baby finger may be adjoined as illustrated in FIG. 4.

On the other hand, operations of the fingers illustrated in FIG. 4 are just an example. It should be understood that the finger recognition device 100 of an embodiment of the inventive concept may recognize the user's fingers by finger operations constituted by various combinations of the thumb, index finger, middle finger, ring finger, and baby finger.

On the other hand, as illustrated in FIGS. 1 and 4, fingers that become a transmission path of a biometric signal are of one hand (namely, any one of the right hand and left hand). However, an embodiment of the inventive concept is not necessary to be limited thereto. The finger recognition device 100 according to an embodiment of the inventive concept may use, as transmission paths of the biometric signal, any one finger of the left hand and any one finger of the right hand of the user.

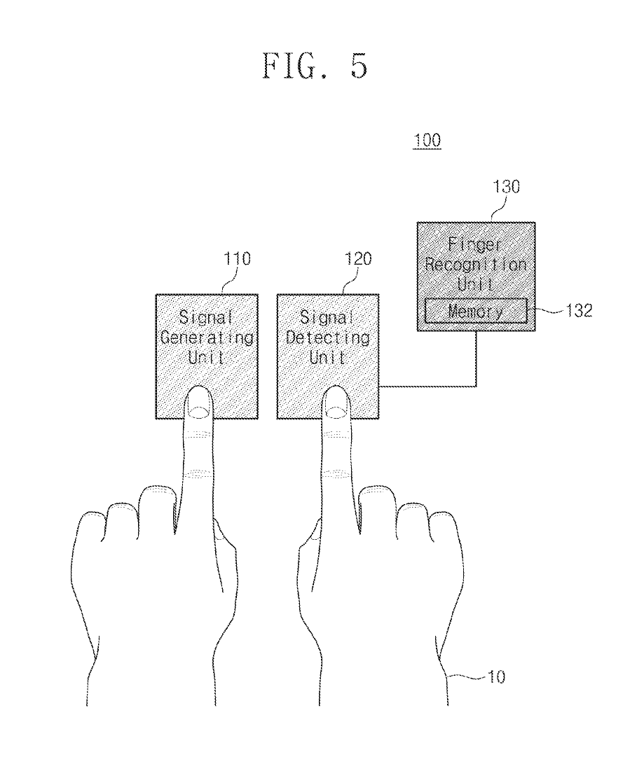

FIG. 5 illustrates another embodiment of a finger operation for finger recognition of a finger recognition device 100 according to an embodiment of the present inventive concept. Referring to FIG. 5, the finger recognition device 100 may recognize the user's finger through any one finger (e.g., the index finger) of the user's left hand touched on the signal generating unit 110 and any one finger (e.g. the index finger) of the user's right hand touched on the signal detecting unit 120.

On the other hand, in FIG. 5, each of the signal generating unit 110 and the signal detecting unit 120 is touched by one finger. However, an embodiment of the inventive concept is not limited thereto. It should be understood that the signal generating unit 110 may be touched by at least one user's finger and the signal detecting unit 120 may be touched by at least one finger in the finger recognition device 100 of the inventive concept.

In addition, the finger recognition device and method of an embodiment of the inventive concept may have characteristics capable of distinguishing fingers of individuals by means of characteristics other than the mentioned characteristics in detecting a distorted signal and distinguishing characteristics.

For example, the finger recognition device of an embodiment of the inventive concept may make an intentional signal distortion by wearing a specific structure such as a ring to use the signal distortion as unique recognition information.

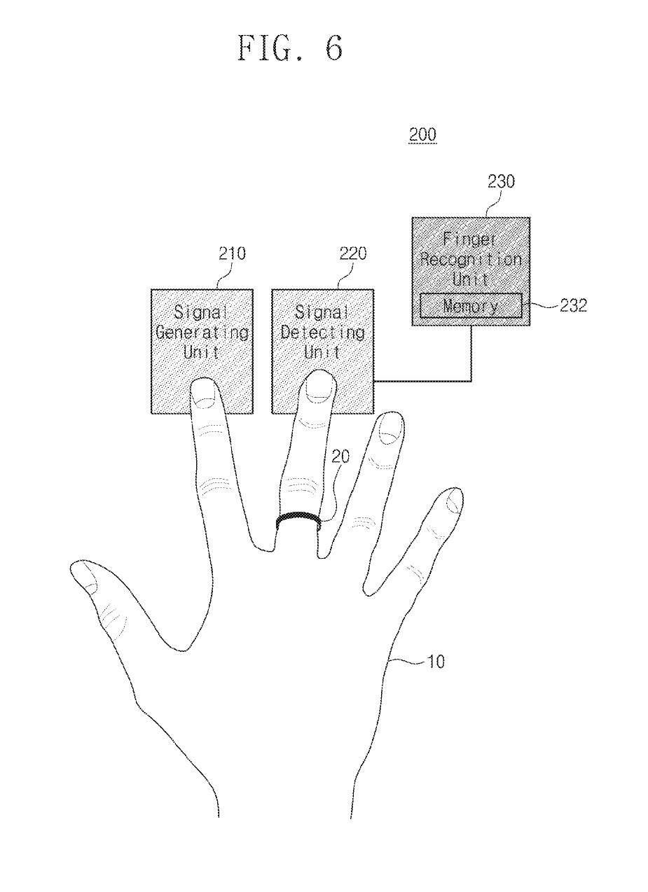

FIG. 6 illustrates an exemplary finger recognition device according to another embodiment of the inventive concept. Referring to FIG. 6, a finger recognition device 200 may include a signal generating unit 210, a signal detecting unit 220, and a finger recognition unit 230. The finger recognition device 200 has differences from that of FIG. 1 in that a ring for finger recognition 20 is used on a finger 10.

FIG. 7 is an exemplary flowchart illustrating a finger recognition method of the finger recognition device 200 of FIG. 6. Referring to FIGS. 6 and 7, the finger recognition method further includes an operation S205 in comparison with that illustrated in FIG. 3. In operation S205, the user may wear a specific ring on a finger for finger authentication of the user. A finger recognition operation may be performed in a state where the specific ring is worn on the finger. Operations S210, S220, and S230 of FIG. 7 may respectively perform the same operations as operations S110, S120, and S130 of FIG. 3.

On the other hand, the finger recognition device and method of an embodiment of the inventive concept may be realized to make an additional distortion to the biometric signal by varying finger's shape during recognizing finger information.

On the other hand, the finger recognition device and method may be realized to have a plurality of signal generating units and signal detecting units using a plurality of fingers, and thereby to recognize more accurate information about individuals.

On the other hand, the finger recognition device according to an embodiment of the inventive concept may be realized to be combined with typical recognition devices to perform user authentication.

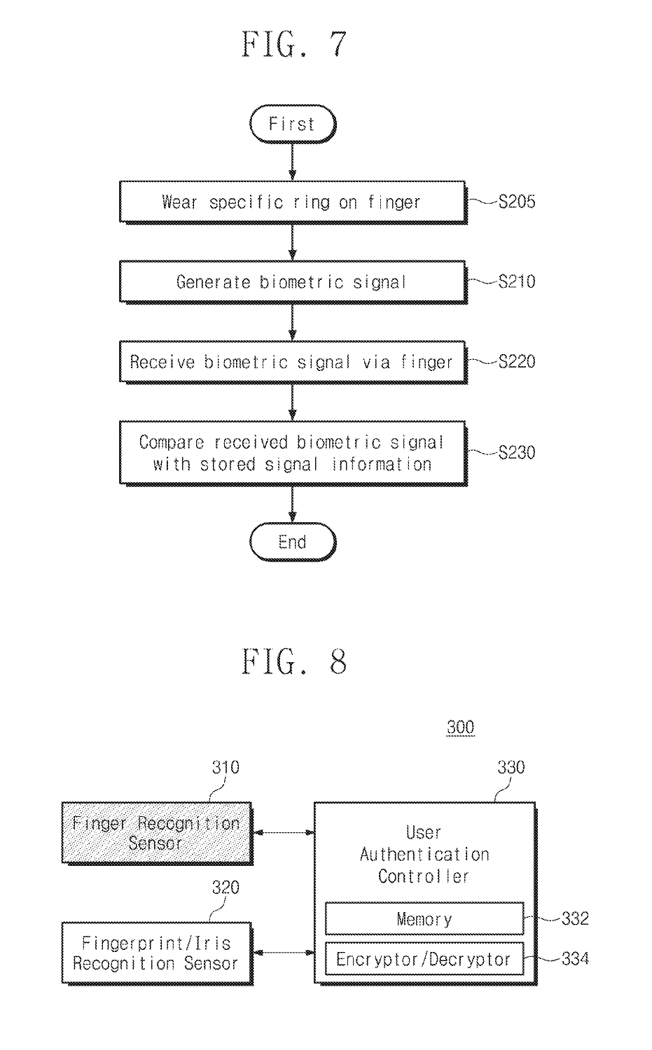

FIG. 8 illustrates an exemplary user authentication device according to an embodiment of the present inventive concept. Referring to FIG. 8, a user authentication device 300 may include a finger recognition sensor 310, a fingerprint/iris recognition sensor 320, and a user authentication controller 330 for controlling them.

The finger recognition sensor 310 may be realized as the finger recognition device described in relation to FIGS. 1 to 8. The fingerprint/iris recognition sensor 320 may be realized to recognize a user's fingerprint or a user's iris.

The user authentication controller 330 may activate at least one of the finger recognition sensor 310 and the fingerprint/iris recognition sensor 320 in response to an authentication request of the user.

The user authentication controller 330 may include a memory 332 and an encryptor/decryptor 334. In an embodiment, the memory 332 may store signal information corresponding to fingerprint information or signal information corresponding to a finger, which is necessary for user authentication. In an embodiment, the encryptor/decryptor 334 may be realized to encrypt/decrypt the fingerprint information or signal information. On the other hand, the memory 332 and the encryptor/decryptor 334 exist inside the user authentication controller 330. However, it should be understood that positions of the memory and encryptor/decryptor of an embodiment of the inventive concept are not necessary to be limited thereto.

In addition, hereinafter, user authentication by the finger recognition sensor 310 will be referred to first user authentication, and user authentication by other components will be referred to second user authentication. The second user authentication illustrated in FIG. 8 is user authentication using a fingerprint/iris. However, the second user authentication is not necessary to be limited thereto. The second user authentication may be any type of user authentication except for the finger recognition and fingerprint/iris recognition of an embodiment of the inventive concept. For example, the second user authentication may be pattern authentication or password authentication.

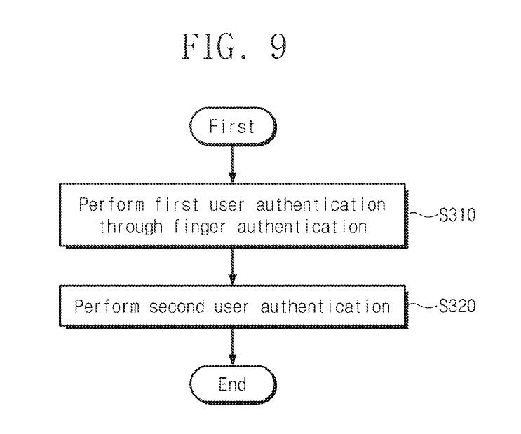

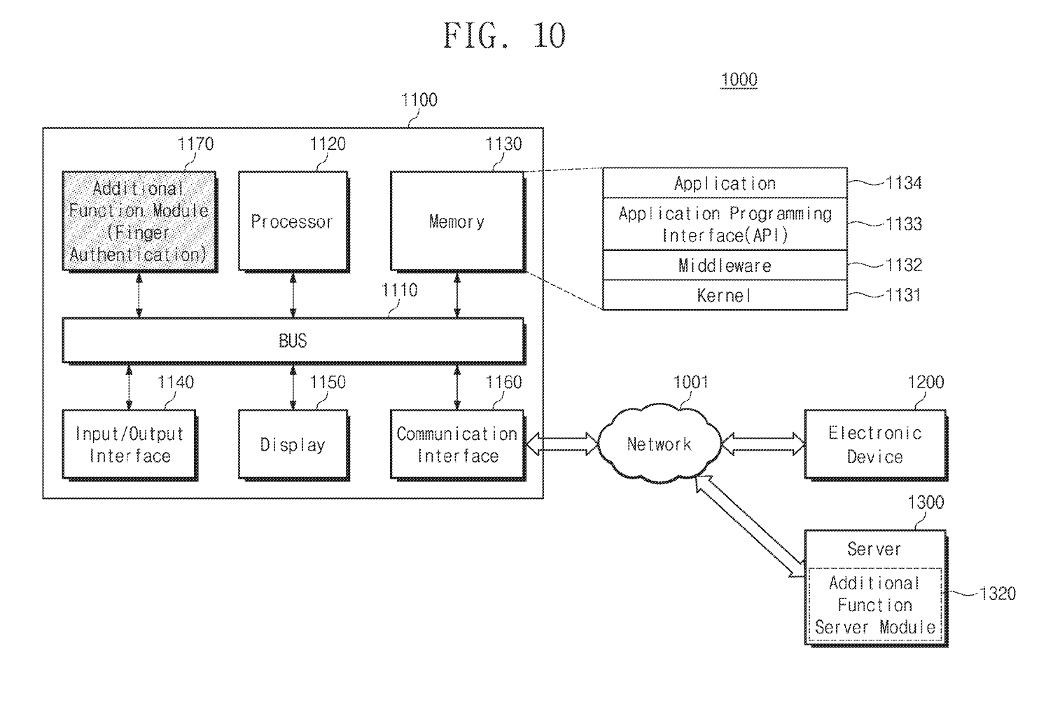

FIG. 9 is an exemplary flowchart illustrating a user authentication method of the user authentication device 300 of FIG. 8. Referring to FIGS. 8 and 9, the user authentication method of the user authentication device 300 may be performed as the following.

The finger recognition sensor 310 may generate, detect, and compare a biometric signal to perform the first user authentication for authenticating a user's finger (operation S310).

Next, the user authentication controller 330 may determine whether the second user authentication is necessary and if necessary, activate the fingerprint/iris recognition sensor 320. The fingerprint/iris recognition sensor 320 may recognize the fingerprint/iris of the user to perform the second user authentication. For example, when high level authentication such as financial transaction is necessary, the second user authentication may be further added after the finger authentication.

FIG. 10 illustrates an exemplary network environment 1000 including an electronic device 1100 according to various embodiments. Referring to FIG. 10, the electronic device 1100 may include a bus 1110, a processor 1120, a memory 1130, an input/output interface 1140, a display 1150, a communication interface 1160, and an additional function module 1170.

The bus 1110 may be a circuit for connecting the foregoing components to each other and delivering communication (e.g. a control message etc.) between the components. The processor 1120 may receive a command from the foregoing other components (e.g. at least one of the memory 1130, the input/output interface 1140, the display 1150, the communication interface 1160, and the additional function module 1170, etc.) through the bus 1110, decipher the received command, and perform an operation or data processing according to the deciphered command

The memory 1130 may store a command or data received from or generated by the processor 1120 or other components (e.g. one of the input/output interface 1140, the display 1150, the communication interface 1160, and the additional function module 1170, etc.). The memory 1130 may include programming modules, for example, a kernel 1131, middleware 1132, an application programming interface (API) 133, or an application 1134. The above-described programming modules may be configured from software, firmware, hardware, or a combination of at least two of them.

The kernel 1131 may control or manage system resources (e.g. at least one of the bus 1110, processor 1120, and memory 1130, etc.) used for executing an operation or function realized in the other remaining programming modules, for example, the middleware 1132, API 1133, or application 1134. In addition, the kernel 1131 may provide an interface through which the middleware 1132, API 1133, or application 1134 may access an individual component of the electronic device 1100 to perform a control or management.

The middleware 1132 may perform a mediation role to enable the API 1133 or the application 1134 to communicate with the kernel 1131 to transmit and receive data. In addition, in relation to operation requests received from the application 1134, the middleware 1132 may perform a control (e.g. at least one of scheduling and load balancing, etc.) on an operation request by using a method of arranging priority capable of using a system resource (e.g. at least one of the bus 1110, the processor 1120, and the memory 1130, etc.) of the electronic device 1100 to at least one application among the applications 1134.

The API 1133 is an interface for the application 1134 to control a function provided in the kernel 1131 or middleware 1132, and may include, for example, at least one interface or function (e.g. a command, etc.) for at least one of a file control, a window control, image processing, and character processing, etc.

In various embodiments, the application 1134 may include at least one of a short message service (SMS)/multimedia messaging service (MMS) application, an email application, a calendar application, an alarm application, a health care application (e.g. an application for measuring at least one of an exercise amount and blood sugar, etc.), and an environmental information application (e.g. an application for providing at least one of atmospheric pressure, humidity, and temperature information, etc.).

Additionally or alternatively, the application 1134 may be an application related to information exchange between the electronic device 1100 and an external electronic device (e.g. an electronic device 1200 etc.). The application related to the information exchange may include, for example, a notification relay application for relaying specific information to the external electronic device or a device management application for managing the external electronic device.

For example, the notification relay application may include a function for relaying notification information generated in another application (e.g. the SMS/MMS application, the email application, the health care application, or the environmental information application, etc.) of the electronic device 1100 to the external electronic device (e.g. the electronic device 1200, etc.).

Additionally or alternatively, the notification relay application may receive the notification information from, for example, the external electronic device (e.g. the electronic device 1200, etc.) to provide the same to the user. The device management application may manage (e.g. at least one of installation, removal, and update, etc.), for example, a function (e.g. turn-on/turn-off of the external device itself (or some components), adjustment of the brightness (or the resolution) of a display) for at least a part of the external electronic device (e.g. the electronic device 1200, etc.) communicating with the electronic device 1100, an application operating in the external electronic device, or a service (e.g. a call service or a messaging service, etc.) provided by the external electronic device.

In an embodiment, the application 1134 may include an application designated according to attributes (e.g. a type of the electronic device, etc.) of the external electronic device (e.g. the electronic device 1200, etc.). For example, when the external electronic device is an MP3 player, the application 1134 may include an application related to music playing. Similarly, when the external electronic device is a mobile medical device, the application 1134 may include an application related to health care. In an embodiment, the application 1134 may include at least one of an application designated in the electronic device 1100 and an application received from the external electronic device (e.g. the server 1300 or electronic device 1200, etc.).

The input/output interface 1140 may deliver a command or data input from the user through an input/output device (e.g. at least one of a sensor, keyboard, and touch screen, etc.) to at least one of the processor 1120, the memory 1130, the communication interface 1160, and the additional function module 1170, etc.

through, for example, the bus 1110.

For example, the input/output interface 1140 may provide data for a user's touch input through a touch screen to the processor 1120. In addition, the input/output interface 1140 may output, through the input/output device (e.g. at least one of a speaker and a display, etc.), a command or data received from at least one of the processor 1120, the memory 1130, the communication interface 1160, and the additional function module 1170, etc., through, for example, the bus 1110. For example, the input/output interface 1140 may output voice data processed by the processor 1120 to the user through the speaker.

The display 1150 may display various information (e.g. at least one of multimedia data and text data, etc.) to the user.

The communication interface 1160 may connect communication between the electronic device 1100 and the external electronic device (e.g. the electronic device 1200 or the server 1300, etc.). For example, the communication interface 1160 may be connected to a network 1001 through wireless communication or wired communication to communicate with the external electronic device.

The wireless communication may include at least one of, for example, wireless fidelity (WiFi), WiFi direct, Bluetooth (BT), near field communication (NFC), global positioning system (GPS), and cellular communication (e.g. LTE, LTE-A, CDMA, WCDMA, UMTS, WiBro or GSM, etc.). The wired communication may include at least one of, for example, universal serial bus (USB), high definition multimedia interface (HDMI), recommended standard 232 (RS-232), and plain old telephone service (POTS), etc.

In an embodiment, the network 1001 may be a telecommunications network. The communication network may include at least one of a computer network, the internet, an internet of things, and a telephone network, etc. In an embodiment, a protocol (e.g. a transport layer protocol, a data link layer protocol, or a physical layer protocol, etc.) for communication between the electronic device 1100 and the external electronic device may be supported by at least one of the application 1134, the API 1133, the middleware 1132, the kernel 1131, and the communication interface 1160, etc.

In an embodiment, the additional function module 1170 may perform at least one of operations (or functions) realized in the electronic device 1100 to support the drive of the electronic device 1100. For example, the server 1300 may include an additional function server module 1320 capable of supporting the additional function module 1170 realized in the electronic device 1100. For example, the additional function server module 1320 may include at least one component of the additional function module 1170 to perform (e.g. do as a proxy) at least one of operations performed by the additional function module 1170.

The additional function module 1170 may process at least a portion of information obtained from at least one of other components (e.g. at least one of the processor 1120, the memory 1130, the input/output interface 1140, and the communication interface 1160, etc.) and use the processed information in various ways. For example, the additional function module 1170 may control at least some functions of the electronic device 1100 by using the processor 1120 or independently therefrom such that the electronic device 1100 interacts with another electronic device (e.g. the electronic device 1200 or the server 1300, etc.). The additional function module 1170 may be integrated into the processor 1120 or the communication interface 1160. In an embodiment, at least one configuration of the additional function module 1170 may be included in the server 1300 (e.g. the additional function server module 1320 etc.) and be supported, by the server 1300, with at least one operation realized in the addition function module 1170.

The additional function module 1170 of an embodiment of the inventive concept may include a function for performing the finger recognition or for performing user authentication through the finger recognition as described in relation to FIGS. 1 to 10.

On the other hand, an embodiment of the inventive concept may provide a health care service to various types of electronic devices.

On the other hand, the finger recognition device of an embodiment of the inventive concept is applicable to a mobile device.

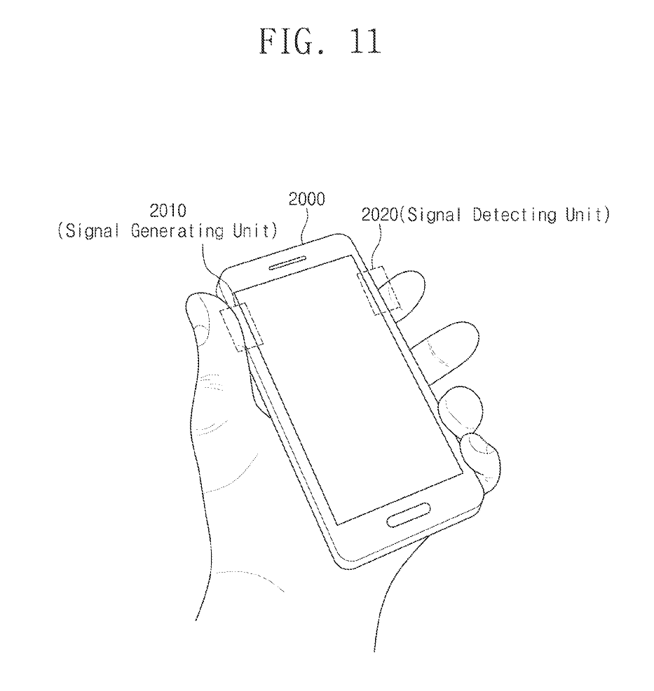

FIG. 11 is an exemplary mobile device according to an embodiment of the present inventive concept. Referring to FIG. 11, a signal generating unit 2010 may be disposed at at least one portion touched when the user grips a mobile device 2000 with one hand, and a signal detecting unit 2020 may be disposed at at least the other portion. Implementation may be achieved such that a finger authentication operation is performed when the user's hand grips the mobile device 2000, and the mobile device 2000 is activated when user authentication is completed.

Each block in the flow charts and/or block diagrams and the combination of the blocks therein may be obviously realized by computer program commands These computer program commands can be supplied to a processor of a general purpose computer, a special purpose computer or a processor of another programmable data processing device. When executed by the processor, the commands produce a means for realizing functions, operations or specific events in each block in the flow charts and/or block diagrams or a combination thereof.

In this regard, each block in the flowchart or block diagrams may correspond to a module, a segment, or a portion of code. Here, the portion of code may include one or more executable instructions for implementing a specific logical function. On the other hand, a function associated with an arbitrary block may occur out of the order noted in the figures. For example, two blocks shown in succession may, in fact, be executed substantially concurrently, or in the reverse order.

It should be understood that persons skilled in the art may implement the technical spirit of the present disclosure with a device, system, method or a computer program product. Accordingly, the present disclosure can be embodied as many forms such as pure hardware embodiment, pure software embodiment which comprises firmware, terminate-and-stay-resident programs, and micro-code programs, as well as embodiment of combination of hardware and software, which will be referred to “circuits”, “modules”, or “systems” in this specification. The combination of hardware and software may include a computer program product embodied on a computer-readable medium having computer-readable program codes.

The present disclosure may use the difference in unique characteristics of a body such as a finger to distinguish and recognize individuals. For a finger, since there is a clear difference in configuration of bone and skin, or configurations of blood vessel and blood in the blood vessel, reproduction is impossible, and a difference between result values according to the environment is small, the present disclosure in which signal transmission characteristics are caught through this has a recognition security scheme of a high recognition rate.

A finger recognition device according to an embodiment of the present invention, a user authentication device including the same, and a finger recognition method thereof may easily recognize a finger of a user by detecting and comparing signals delivered through the finger.

On the other hand, the foregoing description is about specific embodiments for practicing the present invention. The present invention encompasses the technical spirit of abstract and conceptual idea that may be used as a future technology as well as specific and actually useable means.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A finger recognition device comprising:
a signal generating unit configured to generate a biometric signal;
a signal detecting unit configured to receive the biometric signal via a finger and detect the biometric signal; and
a finger recognition unit configured to compare the detected biometric signal with stored signal information to recognize the finger.

2. The finger recognition device of claim 1, wherein the signal generating unit and the signal detecting unit are electrically separated.

3. The finger recognition device of claim 1, wherein the finger recognition unit stores the detected biometric signal as the signal information at a time of enrolling finger information.

4. The finger recognition device of claim 3, wherein the finger recognition unit encrypts the detected biometric signal and stores the encrypted biometric signal as the signal information.

5. The finger recognition device of claim 4, wherein the finger recognition unit decrypts the encrypted biometric signal and compares the detected biometric signal with the signal information.

6. The finger recognition device of claim 1, wherein the signal generating unit and the signal detecting unit are activated, when the signal generating unit is touched by a first finger of a user and the signal detecting unit is touched by a second finger of the user.

7. The finger recognition device of claim 1, wherein the signal detecting unit detects the biometric signal, when the finger is worn with a specific ring.

8. A user recognition device comprising:
a fingerprint recognition sensor configured to recognize a fingerprint;
a finger recognition sensor configured to recognize a finger; and
a user recognition controller configured to control the fingerprint recognition sensor and the finger recognition sensor,
wherein the finger recognition sensor comprises:
a signal generating unit configured to generate a biometric signal;
a signal detecting unit configured to receive the biometric signal via the finger to detect the biometric signal; and
a finger recognition unit configured to compare the detected biometric signal with stored signal information to recognize the finger.

9. The user recognition device of claim 8, wherein the user recognition controller primarily activates the fingerprint recognition sensor.

10. The user recognition device of claim 8, wherein the user recognition controller activates the finger recognition sensor after recognition of the fingerprint by the fingerprint recognition sensor.

11. The user recognition device of claim 8, further comprising a memory configured to store the signal information.

12. The user recognition device of claim 11, wherein the finger recognition unit is realized in a touch screen.

13. The user recognition device of claim 8, wherein at least one of the fingerprint recognition sensor and the finger recognition sensor recognizes fingerprints or fingers of a plurality of users.

14. A user authentication device comprising:
a personal identification number (PIN)/pattern inputter configured to input a PIN or pattern for first user authentication;
a finger recognition sensor configured to recognize a finger for second user authentication; and
a user recognition controller configured to control the PIN/pattern inputter and the finger recognition sensor,
wherein the finger recognition sensor comprises:
a signal generating unit configured to generate a biometric signal;
a signal detecting unit configured to receive the biometric signal via the finger to detect the biometric signal; and
a finger recognition unit configured to compare the detected biometric signal with stored signal information to recognize the finger.

15. The user authentication device of claim 14, wherein the user authentication device is a wearable device.

16. A finger recognition method of a user authentication device, the finger recognition method comprising:
generating a biometric signal;
receiving the biometric signal via a finger; and
comparing the received biometric signal with signal information.

17. The finger recognition method of claim 16, further comprising wearing a specific finger on the finger.

18. The finger recognition method of claim 16, further comprising storing the signal information in a memory inside the user recognition device.

19. The finger recognition method of claim 18, wherein the storing of the signal information comprises encrypting the signal information.

20. The finger recognition method of claim 16, further comprising detecting a touch by the finger.
